(19) United States
(12) Patent Application Publication
(10) Pub. No.: US 2023/0169482 A1
(43) Pub. Date: Jun. 1, 2023

(54) COMMODITY DATA REGISTRATION APPARATUS AND PAYMENT SYSTEM

(71) Applicant: TOSHIBA TEC KABUSHIKI KAISHA, Tokyo (JP)

(72) Inventor: Shunichiro KAMAMOTO, Izunokuni Shizuoka (JP)

(21) Appl. No.: 17/960,731

(22) Filed: Oct. 5, 2022

(30) Foreign Application Priority Data
Dec. 1, 2021 (JP) 2021-195613

(51) Int. Cl. G06Q 20/20

(52) U.S. Cl. CPC G06Q 20/208

(57) ABSTRACT

According to one embodiment, a commodity data registration apparatus is connectable to a commodity data input apparatus via a network and includes a processor to acquire, from the commodity data input apparatus, commodity identification information associated with time information indicating the time when identification information was input to the commodity data input apparatus, to register commodity information in a transaction based on the acquired commodity identification information, and to receive a transaction start declaration and a transaction closing declaration. The processor includes commodity information registered between the transaction start and closing as transaction information, which is then output to a payment processing apparatus. If the time associated with the commodity identification information is before the transaction start time, the commodity information associated with the commodity identification information is not included in the transaction information.

### CROSS-REFERENCE TO RELATED APPLICATION

This application is based upon and claims the benefit of priority from Japanese Patent Application No. 2021-195613, filed Dec. 1, 2021, the entire contents of which are incorporated herein by reference.

### FIELD

Embodiments described herein relate to a commodity data registration apparatus, a payment system, and a method of operating such an apparatus or system.

### BACKGROUND

In recent years, a point of sales (POS) system called a cart-based POS (also more simply, a “cart POS”) has been put into practical use. With a cart POS, a customer registers commodity information (performs a “commodity registration”) by himself or herself by using an information terminal, such as a tablet terminal or a smartphone, mounted on a shopping cart or the like, and the registered commodity information is then wirelessly transferred to a payment apparatus.

Against this background of the spread of wireless techniques in POS systems, certain devices, such as a scanner that reads a commodity code, may be connected to a registration apparatus via a wireless network or the like. However, it is found that certain problems occur when the scanner and the registration apparatus are connected by wireless communication.

For example, a communication time lag may occur depending on a communication state of the network, and the registration apparatus may receive the commodity code transmitted by the scanner with some delay. When an operator reads the commodity code using the scanner and then immediately executes a closing input that declares end of a transaction, the registration apparatus may receive the just scanned commodity code after the closing input is already executed. As a result, a problem arises that a payment process is not appropriately executed, such as the commodity identified by the commodity code is included in another transaction rather than the present transaction.

This problem is most obvious in a POS terminal in which the registration apparatus and the payment apparatus are operated by different operators, such as a POS terminal called two-person type (see, for example, JP-A-2011-54054). This is because an operator of the payment apparatus can only perform the payment process based on transaction information as supplied and does not perform the reading operation(s) of the commodity code, and thus the operator cannot check whether all the commodity information read by the scanner is appropriately included in the transaction information.

### BRIEF DESCRIPTION OF THE DRAWINGS

FIG. 1 is a diagram of a store system including a payment system according to an embodiment.

FIG. 2 is a diagram showing an arrangement of apparatuses of a payment system.

FIG. 3 is a block diagram of a registration apparatus.

FIG. 4 is a diagram of a registration information unit.

FIG. 5 is a block diagram of a control unit.

FIG. 6 is a block diagram of a payment apparatus.

FIG. 7 is a block diagram of a control unit.

FIG. 8 is a sequence chart showing a flow of operations of a payment system.

FIG. 9 is a flowchart of a registration process.

FIG. 10 is a flowchart of a checkout process.

### DETAILED DESCRIPTION

In general, a commodity data registration apparatus, a payment system, and a method for optimizing a transaction payment process are provided.

According to one embodiment, a commodity data registration apparatus that is connectable to a commodity data input apparatus via a network, comprises a processor. The processor is configured to: acquire, from a commodity data input apparatus, commodity identification information and associated time information indicating a time at which the commodity identification information was input to the commodity data input apparatus; register commodity information in a transaction based on the acquired commodity identification information; receive a transaction start to declare a start of a transaction from an operator input unit; receive a transaction closing to declare an end of the transaction from the operator input unit; include commodity information registered during a period between the transaction start of the transaction and the transaction closing of the transaction in transaction information; and output the transaction information to a payment processing apparatus. When the time indicated by the time information associated with the commodity identification information is earlier than the time at which the transaction start is received, the commodity information of the commodity associated with the commodity identification information is not included in the transaction information sent to the payment processing apparatus.

Hereinafter, a commodity data registration apparatus, a payment system, and a method according to certain example embodiments will be described with reference to drawings. The present disclosure is not limited to these example embodiments. For example, while in one example, a commodity data registration apparatus is described as a registration apparatus that is provided separately from a payment apparatus, the commodity data registration apparatus in other examples may be a POS terminal that executes a payment process in addition to commodity registration. In one example, the payment system is described as being a two-person type POS system in which the operators of the registration apparatus and the payment apparatus may both be store clerks, but in other examples the payment system may be a so-called “semi-self-service-type POS system” in which the operator of the registration apparatus is a store clerk but the operator of the payment apparatus is a customer.

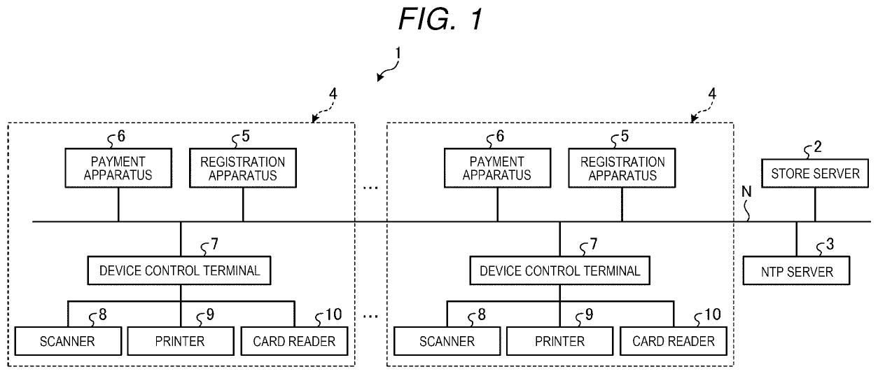

FIG. 1 is a diagram showing a configuration of a store system 1. The store system 1 includes a store server 2, a network time protocol (NTP) server 3, and a plurality of POS systems 4 (“payment systems”). The store server 2, the NTP server 3, and the POS systems 4 are communicably connected to each other via a network N. The network N is, for example, a wired or wireless local area network (LAN).

The store server 2 receives commodity information and settlement information for a commodity settled (paid for) in a payment process at each of the POS systems 4. In addition, the store server 2 receives, from each POS system 4, checkout information in which the commodity sales over the course of a predetermined period (for example, one day) are provided. The store server 2 manages (tracks) the commodity information, the settlement information, the checkout information, and the like received from each POS system 4, and executes sales management and the like for the store.

The store server 2 stores a commodity master. The commodity master is a master file that stores commodity codes for identifying commodities and the commodity information (commodity names, prices, and the like) in association with each other for the commodities that are available in the store. Since the commodities that are available in the store might change every day or the like, the commodity master may be appropriately updated. The store server 2 transmits the updated commodity master to each POS system 4 as necessary. The commodity code is an example of commodity identification information.

The NTP server 3 outputs time information to each apparatus connected via the network N, and thus synchronizes the time for each apparatus. The NTP server 3 may receive the time information from a higher-level NTP server via a network such as the Internet.

The POS system 4 is a two-person type POS system and includes a registration apparatus 5 (commodity data registration apparatus), a payment apparatus 6, and a device control terminal 7. The registration apparatus 5, the payment apparatus 6, and the device control terminal 7 are communicably connected to each other via the network N.

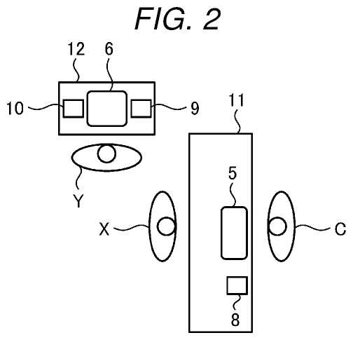

The registration apparatus 5 is operated by a store clerk X (see FIG. 2). The registration apparatus 5 registers commodity information of a commodity to be purchased by a customer C (see FIG. 2), and outputs the registered commodity information of each transaction to the payment apparatus 6 as transaction information. Additional details of the registration apparatus 5 will be described later.

The payment apparatus 6 is operated by a store clerk Y (see FIG. 2) (distinct from the store clerk X) who operates the registration apparatus 5. The payment apparatus 6 executes a payment process based on the transaction information received from the registration apparatus 5. The payment process is a process for the customer C to pay a purchase price of the commodity (or commodities) in the transaction. For example, the payment process includes a process of displaying a transaction amount (a total amount of the prices of the commodities in one transaction), a process related to making change (change return), a process related to credit settlement, a process related to receipt printing, and the like. Additional details of the payment apparatus 6 will be described later.

The device control terminal 7 controls a scanner 8, a printer 9, and a card reader 10 (hereinafter, these may be collectively referred to as “devices” or “peripheral devices”). The device control terminal 7 is communicably connected to each of the devices independently from the network N. Therefore, the device control terminal 7 can transmit and receive information to and from each device without being affected by a communication state of the network N.

The scanner 8 is a code scanner (e.g., a barcode scanner) that reads the commodity code of a commodity from a code symbol attached to the commodity, such as a barcode or other two-dimensional code. In some examples, the scanner 8 may be or include a radio frequency identification (RFID) reader that reads the commodity code from a wireless tag attached to the commodity. The scanner 8 inputs the read commodity code to the device control terminal 7. The device control terminal 7 is one example of an input apparatus to which the commodity code is sent. In some examples, the scanner 8 may be directly connected to the network N rather than via the device control terminal 7, in which case, the scanner 8 would itself be another example of an input apparatus.

The printer 9 prints and dispenses a receipt. The receipt is printed with the commodity information of the transaction, the transaction amount, an advertisement, and the like.

The card reader 10 reads a membership code from a medium such as a membership card or a point card of the customer C. Furthermore, the card reader 10 may also read information (credit information) necessary for a credit card settlement from a credit card provided by the customer. The card reader 10 may be a magnetic card reader that reads information from a magnetic card, or may be an integrated circuit (IC) card reader that reads information from a card incorporating an IC chip.

FIG. 2 is a diagram showing an arrangement of the apparatuses of the POS system 4 according to the present embodiment. Each apparatus of the POS system 4 is placed on a counter table 11 or a counter table 12. The registration apparatus 5 and the scanner 8 are placed on the counter table 11. The payment apparatus 6, the printer 9, and the card reader 10 are placed on the counter table 12.

The customer C brings the commodity to be purchased to the counter table 11. The store clerk X reads, by the scanner 8, the commodity code of the commodity. The registration apparatus 5 acquires the commodity code read by the scanner 8 via the device control terminal 7 and the network N, and executes commodity registration based on the commodity code. When the commodity registration of all commodities to be purchased by the customer C is completed, the store clerk X executes a closing input that declares the end of the one transaction, in other words, completion of the commodity registration.

When closing information is input to the registration apparatus 5, the registration apparatus 5 outputs the registered commodity information for the transaction to the payment apparatus 6 as the transaction information. At this time, the store clerk X prompts the customer C to move to the payment apparatus 6. In the following description, a transaction before the closing information is input may be referred to as a “current transaction” or a “first transaction”, and a transaction in which the commodity registration is executed after the current transaction may be referred to as a “next transaction” or a “second transaction”. In addition, when the commodity registration of the second transaction is started, the first transaction may be referred to as an “immediately preceding transaction”. In the present embodiment, after the closing information is input, the registration apparatus 5 can acquire a commodity code of a commodity related to the next transaction from the device control terminal 7 via the network N, regardless of whether the payment process of the current transaction has been completed at the payment apparatus 6. That is, in the present embodiment, the closing information indicates that input of the commodity code for the next transaction can be started, and also serves as input start information that declares start of the next transaction. In this case, the registration apparatus 5 registers the commodity identified by the acquired commodity code as a commodity to be purchased in the next transaction (the second transaction). In some examples, transaction start information that declares the start of the next transaction may be input separately from the closing information.

The payment apparatus 6 executes the payment process based on the transaction information received from the registration apparatus 5 by an operation of the store clerk Y. The customer C moves to the counter table 12 to pay the required purchase price. In a case of cash payment, the customer C hands over cash to the store clerk Y. In a case of the credit card settlement, the customer C uses the card reader 10 to read the credit information from the credit card. When the payment process is completed, the customer C receives the receipt dispensed by the printer 9.

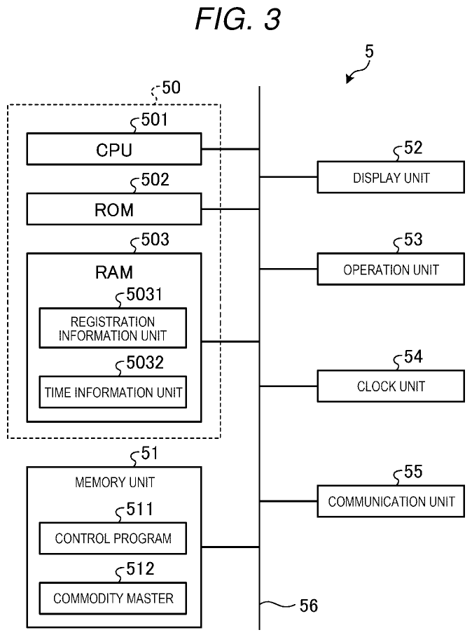

Next, the registration apparatus 5 will be described. FIG. 3 is a block diagram showing a hardware configuration of the registration apparatus 5.

The registration apparatus 5 includes a control unit 50, a memory unit 51, a display unit 52, an operation unit 53, a clock unit 54, and a communication unit 55. The control unit 50, the memory unit 51, the display unit 52, the operation unit 53, the clock unit 54, and the communication unit 55 are communicably connected to each other via a bus 56 or the like.

The control unit 50 includes a central processing unit (CPU) 501, a read only memory (ROM) 502, and a random access memory (RAM) 503. The CPU 501, the ROM 502, and the RAM 503 are connected to each other via the bus 56.

The CPU 501 controls all operations of the registration apparatus 5. The ROM 502 stores various programs such as a program used for driving the CPU 501 and various data. The RAM 503 is used as a work area of the CPU 501, and loads various programs and various data stored in the ROM 502 or the memory unit 51. The control unit 50 executes various control processes of the registration apparatus 5 by the CPU 501 operating in accordance with a control program stored in the ROM 502 or the memory unit 51 and loaded in the RAM 503.

The RAM 503 includes a registration information unit 5031 and a time information unit 5032. The registration information unit 5031 is an area for storing the commodity information and the like of a commodity identified by the commodity code read by the scanner 8. The commodity registration is executed by registering (storing) the commodity information and the like in the registration information unit 5031.

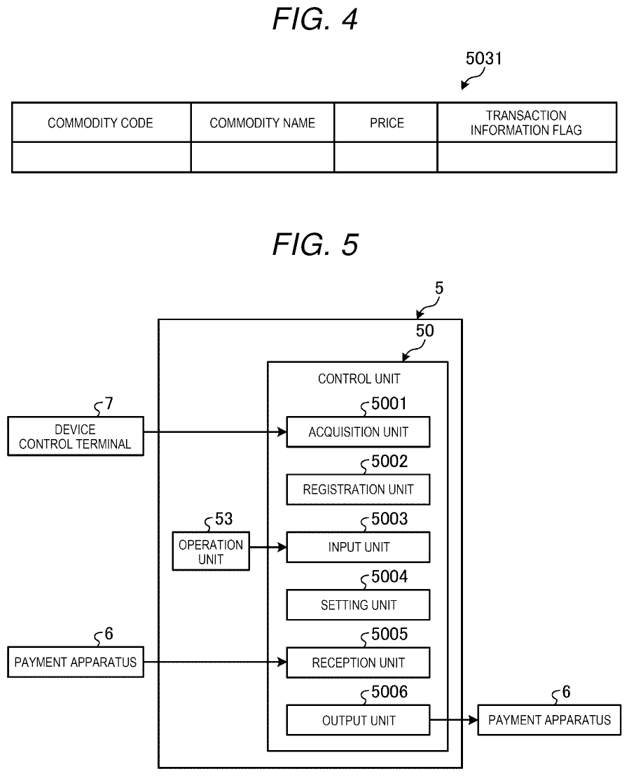

FIG. 4 is a diagram showing a data configuration of the registration information unit 5031. Each piece of data registered in the registration information unit 5031 is associated with information indicating the commodity code, the commodity name, the price, and a transaction information flag.

The commodity code for identifying the commodity is registered as an item in the “commodity code” column. Information indicating a name of the commodity is registered as an item in the “commodity name” column. Information indicating a unit price of the commodity is registered as an item of the “price” column. The unit price of the commodity may be a tax-included price including a consumption tax, or may be a base price not including the consumption tax. Flag information indicating whether the commodity identified by the corresponding commodity code is to be included in the transaction information is registered as a flag value in the “transaction information flag” column.

The time information unit 5032 stores information indicating a time at which the operation unit 53 has been operated, such as the time of the closing input executed by the operation unit 53. The time information unit 5032 stores time information indicating the time as tracked by the clock unit 54, that is, a time synchronized with a time tracked by each apparatus such as the device control terminal 7.

The memory unit 51 includes a storage medium such as a hard disk drive (HDD) or a flash memory and maintains storage content even when a power supply is cut off. The memory unit 51 stores a control program 511 and a commodity master 512.

The control program 511 is a program for executing the commodity registration based on the commodity code acquired from the device control terminal 7, a program for outputting the transaction information from the registered commodity information to the payment apparatus 6, and the like.

The commodity master 512 is the commodity master received from the store server 2. In some examples, the registration apparatus 5 might not store the commodity master 512 in whole or in part. In this case, the registration apparatus 5 outputs an inquiry for commodity information based on the commodity code to the store server 2 as necessary and acquires the commodity information from the store server 2 to execute the commodity registration.

The display unit 52 is implemented as, for example, a liquid crystal panel or panels, and includes one display for the store clerk X (operator display unit) and another display for the customer C (customer display unit). The display unit 52 displays various kinds of information. For example, the operator display unit and the customer display unit display the commodity information of each registered commodity. The operator display unit can display a commodity registration screen for inputting a commodity code of a commodity to which no code symbol is physically attached. In addition, the customer display unit can display advertisement information during the registration process.

The operation unit 53 is used for inputting information to the control unit 50, and includes a keyboard, a touch panel provided on a surface of the display unit 52, and the like. For example, the operation unit 53 inputs the commodity code of the commodity to which no code symbol is attached to the control unit 50 by an operation of the store clerk X. In addition, the operation unit 53 inputs the closing information that declares the completion of the commodity registration of the one transaction to the control unit 50 by an operation of the store clerk X.

The clock unit 54 tracks a current time. The clock unit 54 tracks, based on the time information from the NTP server 3, the time synchronized with various apparatuses that are connected via the network N, including the device control terminal 7.

The communication unit 55 is an interface for communicating with an external apparatus such as the store server 2, the NTP server 3, the payment apparatus 6, or the device control terminal 7. The control unit 50 can transmit and receive information (data) to and from the external apparatus by being connected to the external apparatus via the communication unit 55. For example, the control unit 50 can transmit and receive data to and from the scanner 8 via the communication unit 55 and the device control terminal 7.

Next, a functional configuration of the control unit 50 of the registration apparatus 5 will be described. FIG. 5 is a block diagram showing functional aspects of the control unit 50 of the registration apparatus 5. The control unit 50 functions as an acquisition unit 5001, a registration unit 5002, an input unit 5003, a setting unit 5004, a reception unit 5005, and an output unit 5006 by the CPU 501 operating in accordance with the control program stored in the ROM 502 or the memory unit 51. In some examples, these functions may be implemented using hardware such as a dedicated circuit.

The acquisition unit 5001 acquires, from the input apparatus, the commodity identification information and the time information (first time information) indicating the time at which the commodity identification information is input to the input apparatus. Specifically, the acquisition unit 5001 acquires, from the device control terminal 7, a commodity code and time information (first time information) indicating a time at which the commodity code is input to the device control terminal 7. When the scanner 8 is directly connected to the network N not via the device control terminal 7, the acquisition unit 5001 acquires the commodity code and the first time information from the scanner 8. The first time information acquired by the acquisition unit 5001 from the scanner 8 indicates a time synchronized with the registration apparatus 5 by the NTP server 3.

The registration unit 5002 registers, in the time information unit 5032, information indicating a time at which the closing information is input to the input unit 5003. When the transaction start information is input separately from the closing information, the registration unit 5002 registers, in the time information unit 5032, time information indicating a time at which the transaction start information is input.

In addition, the registration unit 5002 registers the commodity information based on the commodity identification information acquired by the acquisition unit 5001. Specifically, the registration unit 5002 reads, from the commodity master 512, the commodity information corresponding to the commodity code acquired from the device control terminal 7 by the acquisition unit 5001, and registers the commodity information in the registration information unit 5031. The registration unit 5002 registers information indicating the commodity code, the commodity name, and the price as the commodity information in the registration information unit 5031.

Further, the registration unit 5002 registers the flag information in the transaction information flag of the registration information unit 5031. Specifically, when the time information (first time information) acquired by the acquisition unit 5001 corresponding to the commodity code indicates a time later than the time information registered in the time information unit 5032, the registration unit 5002 registers “1” in the transaction information flag. That is, when it is recognized that the commodity code acquired by the acquisition unit 5001 is read by the scanner 8 after closing information input immediately before (current transaction start information), the registration unit 5002 registers “1”, which is flag information indicating that the commodity identified by the commodity code is included in the current transaction.

When the time information (first time information) acquired by the acquisition unit 5001 corresponding to the commodity code indicates a time earlier than the time information registered in the time information unit 5032, the registration unit 5002 registers in the transaction information flag. That is, when it is recognized that the commodity code acquired by the acquisition unit 5001 is read by the scanner 8 before the closing information input immediately before (current transaction start information), the registration unit 5002 registers “0”, which is flag information indicating that the commodity identified by the commodity code is not included in the current transaction.

The transaction start information that declares start of one transaction and the closing information that declares end of the one transaction are input in the input unit 5003. Specifically, the closing information is input from the operation unit 53 to the input unit 5003. As described above, in the present embodiment, the closing information that declares the end of the one transaction also serves as the transaction start information of the transaction that is executed after the one transaction, and the closing information can be said to be an example of the transaction start information.

The setting unit 5004 sets, as the transaction information, the commodity information registered by the registration unit 5002 during a period from when the transaction start information is input to when the closing information is input. However, when the time indicated by the time information (first time information) that is associated with the commodity identification information acquired by the acquisition unit 5001 is earlier the time at which the transaction start information is input to the input unit 5003, the setting unit 5004 sets the transaction information without including the commodity information of the commodity identified by the commodity identification information.

Specifically, when the closing information is input to the input unit 5003, the setting unit 5004 refers to the registration information unit 5031, and sets, as the transaction information, the commodity information in which “1” is registered in the transaction information flag. In other words, the setting unit 5004 sets the transaction information excluding a commodity related to the immediately preceding transaction from the commodities registered during a period from when the closing information of the immediately preceding transaction (transaction start information of the current transaction) is input to when the closing information of the current transaction is input. The excluded commodity is a commodity related to a commodity code that is acquired by the acquisition unit 5001 after the input of the closing information of the immediately preceding transaction due to a communication delay of the network N, even though the commodity code is read before the input of the closing information of the immediately preceding transaction. In other words, the excluded commodity is a commodity to be included in the immediately preceding transaction.

The reception unit 5005 receives, from the payment apparatus 6, completion information indicating completion of the payment process of the one transaction that is ended by the immediately preceding closing information input to the input unit 5003.

The output unit 5006 outputs the transaction information set by the setting unit 5004 to the payment apparatus 6. When the reception unit 5005 does not receive the completion information, the output unit 5006 outputs commodity information that is not included in the transaction information by the setting unit 5004 to the payment apparatus 6. Specifically, when the immediately preceding transaction is not completed by the payment apparatus 6, the output unit 5006 outputs the commodity code of the commodity to be included in the immediately preceding transaction to the payment apparatus 6. Accordingly, the payment apparatus 6 can execute an appropriate payment process of the commodity to be included in the transaction. When the registration apparatus 5 is a POS terminal having functions of the payment apparatus 6, the output unit 5006 outputs the transaction information and the commodity information to a payment processing unit included in the POS terminal.

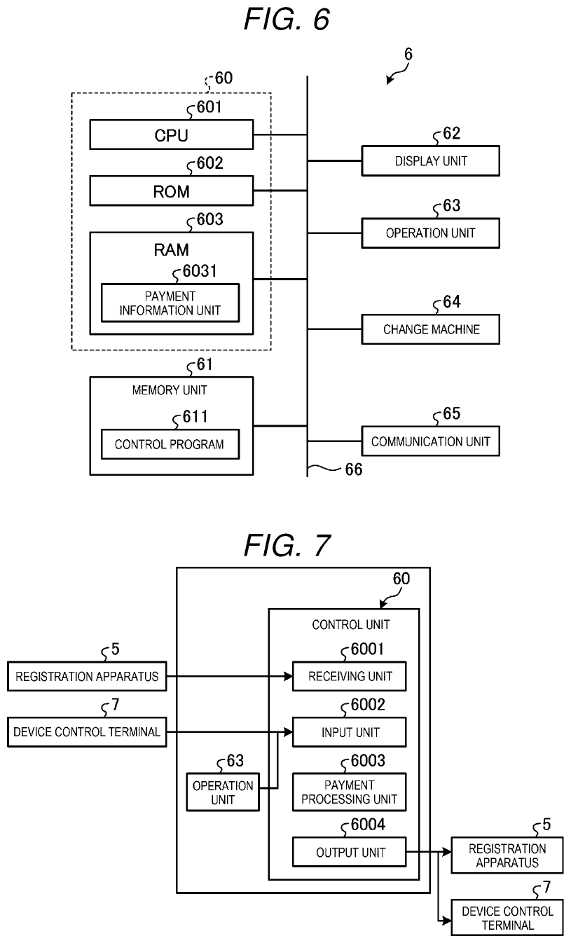

Next, the payment apparatus 6 will be described in detail. FIG. 6 is a block diagram showing a hardware configuration of the payment apparatus 6.

The payment apparatus 6 includes a control unit 60, a memory unit 61, a display unit 62, an operation unit 63, a change machine 64, and a communication unit 65. The control unit 60, the memory unit 61, the display unit 62, the operation unit 63, the change machine 64, and the communication unit 65 are communicably connected to each other via a bus 66 or the like.

The control unit 60 includes a CPU 601, a ROM 602, and a RAM 603. The CPU 601, the ROM 602, and the RAM 603 are connected to each other via the bus 66.

The CPU 601 controls all operations of the payment apparatus 6. The ROM 602 stores various programs such as a program used for driving the CPU 601 and various data. The RAM 603 is used as a work area of the CPU 601, and loads various programs and various data stored in the ROM 602 or the memory unit 61. The control unit 60 executes various control processes of the payment apparatus 6 by the CPU 601 operating in accordance with a control program stored in the ROM 602 or the memory unit 61 and loaded in the RAM 603.

The RAM 603 includes a payment information unit 6031. The payment information unit 6031 associates the transaction information and a transaction ID received from the registration apparatus 5 with each other to store. The transaction ID is information for identifying the transaction information.

The memory unit 61 includes a storage medium such as an HDD or a flash memory, and maintains a stored content even when the power supply is cut off. The memory unit 61 stores a control program 611.

The control program 611 is a program for executing the payment process based on the transaction information received from the registration apparatus 5, a program for executing the payment process by adding the commodity information to the transaction information when the commodity information is received from the registration apparatus 5 during the payment process, and the like.

The display unit 62 is implemented as, for example, a liquid crystal panel or panels, and includes a display for the store clerk Y (operator display unit) and a display for the customer C (customer display unit). The display unit 62 displays various kinds of information. For example, the operator display unit and the customer display unit display a selection screen for selecting a payment method.

The operation unit 63 is used for inputting information to the control unit 60, and includes a keyboard, a touch panel provided on a surface of the display unit 62, and the like. For example, the operation unit 63 inputs information indicating the selected payment method to the control unit 60 by an input operation of the store clerk Y. In addition, the operation unit 63 inputs the completion information indicating the completion of the payment process of a transaction to the control unit 60 by an operation of the store clerk Y.

When the customer C pays the purchase price with cash, the change machine 64 receives banknotes and coins paid by the customer C, and dispenses change as necessary.

The communication unit 65 is an interface for communicating with an external apparatus such as the store server 2, the NTP server 3, the registration apparatus 5, or the device control terminal 7. The control unit 60 can transmit and receive information (data) to and from the external apparatus by being connected to the external apparatus via the communication unit 65. For example, the control unit 60 can transmit and receive data to and from the printer 9 and the card reader 10 via the communication unit 55 and the device control terminal 7.

Next, a functional configuration of the control unit 60 of the payment apparatus 6 will be described. FIG. 7 is a block diagram showing aspects of a functional configuration of the control unit 60 of the payment apparatus 6. The control unit 60 functions as a receiving unit 6001, an input unit 6002, a payment processing unit 6003, and an output unit 6004 by the CPU 601 operating in accordance with the control program stored in the ROM 602 or the memory unit 61. In some examples, these described functions may be implemented using hardware such as a dedicated circuit.

The receiving unit 6001 receives the transaction information from the commodity data registration apparatus. Specifically, the receiving unit 6001 receives, from the registration apparatus 5, the transaction information including the commodity information of the commodity related to the one transaction and the transaction ID for identifying the transaction information. In addition, the receiving unit 6001 receives the commodity information and the transaction ID from the registration apparatus 5 in a state where the payment process by the payment processing unit 6003 is not completed. The commodity information received by the receiving unit 6001 is the commodity information added to the transaction information during the payment process.

For example, the credit information for the customer C to execute the credit card settlement is input from the device control terminal 7 to the input unit 6002. Information on an amount of money received by the store clerk Y from the customer C is input from the operation unit 63 to the input unit 6002. Various kinds of other information is input from the operation unit 63 to the input unit 6002.

The payment processing unit 6003 executes the payment process based on the transaction information received by the receiving unit 6001. The payment processing unit 6003 executes the payment process for the customer C to pay the purchase price by an operation of the store clerk Y.

The output unit 6004 outputs various kinds of information to the external apparatus or the like. For example, the output unit 6004 outputs the completion information indicating the completion of the payment process of the one transaction to the registration apparatus 5. The output unit 6004 may output the completion information based on information from the payment processing unit 6003 or may output the completion information based on an operation of the operation unit 63 performed by the store clerk Y. The output unit 6004 outputs an instruction for the printer 9 to dispense the receipt to the device control terminal 7.

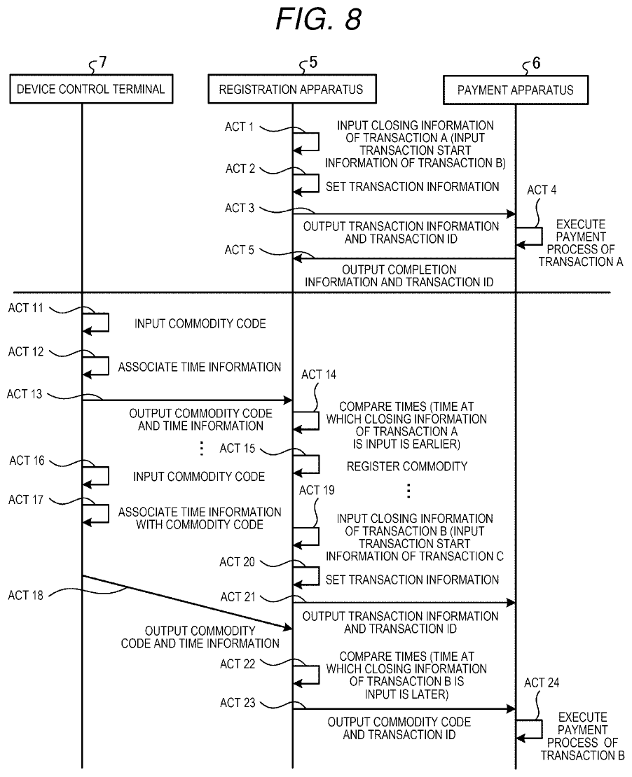

Next, certain operations of the POS system 4 including the above configurations will be described. FIG. 8 is a sequence chart showing a flow of the operations of the POS system 4. The sequence chart shown in FIG. 8 shows a flow of operations of a transaction A executed when a communication time lag of the network N affecting the payment process does not occur, and a transaction B executed after the transaction A and executed when the communication time lag occurs.

When commodity registration of a commodity related to the transaction A is completed, closing information is input to the registration apparatus 5 (ACT 1). The closing information on the transaction A is also the transaction start information of the transaction B that is executed next. Therefore, a commodity code that is acquired from the device control terminal 7 after the input of the closing information on the transaction A is treated as a commodity code of a commodity related to the transaction B (the next transaction). Accordingly, even while the payment apparatus 6 is executing a payment process related to the transaction A, the registration apparatus 5 enables commodity registration related to the transaction B so as to improve an efficiency of customer service in the POS system 4.

When the closing information is input, the registration apparatus 5 sets transaction information (ACT 2). The registration apparatus 5 sets commodity information of the commodity related to the transaction A as the transaction information. Next, the registration apparatus 5 outputs the transaction information and a transaction ID for identifying the transaction information to the payment apparatus 6 (ACT 3).

The payment apparatus 6 executes the payment process of the transaction A based on the received transaction information (ACT 4). When the payment process is completed, the payment apparatus 6 outputs completion information indicating completion of the payment process and the transaction ID to the registration apparatus 5 (ACT 5). Accordingly, the process related to the transaction A is completed.

In the transaction B, first, the commodity code is input from the scanner 8 to the device control terminal 7 (ACT 11). The device control terminal 7 associates time information indicating the time at which the commodity code is input with the input commodity code (ACT 12). Since the device control terminal 7 and the scanner 8 are directly connected to each other not via the network N, substantially no communication time lag occurs. Therefore, the time information associated with the commodity code by the device control terminal 7 can be said to indicate the time at which the commodity code was actually read by the scanner 8. The device control terminal 7 outputs the commodity code and the time information that are associated with each other to the registration apparatus 5 (ACT 13).

The registration apparatus 5 compares the time information acquired from the device control terminal 7 with the time at which the closing information of the transaction A (start information of the transaction B) is input (ACT 14). Here, in this portion of the explanation, it is assumed that the time at which the closing information of the transaction A is input is earlier than the time indicated by the time information acquired by the registration apparatus 5. Subsequently, the registration apparatus 5 registers the commodity as a commodity related to the transaction B based on the commodity code acquired from the device control terminal 7 (ACT 15).

The device control terminal 7 and the registration apparatus 5 repeat the process of ACTs 11 to 15 for each commodity to be purchased by the customer.

A commodity code finally read by the scanner 8 in the transaction B is input to the device control terminal 7 (ACT 16). The device control terminal 7 associates time information indicating a time at which the commodity code was input with the commodity code (ACT 17). Then, the device control terminal 7 outputs the commodity code and the time information that are associated with each other to the registration apparatus 5 (ACT 18).

Closing information of the transaction B is input to the registration apparatus 5 (ACT 19). The store clerk X who operates the scanner 8 and the registration apparatus 5 promptly operates the operation unit 53 to input the closing information of the transaction B after the reading of the last commodity code related to the transaction B is completed by the scanner 8. Next, the registration apparatus 5 sets, as transaction information, commodity information of the commodities registered during the period from when the closing information of the transaction A is input in ACT 1 to when the closing information of the transaction B is input in ACT 19 (ACT 20). The registration apparatus 5 outputs the set transaction information and a transaction ID to the payment apparatus 6 (ACT 21).

At this time, when the communication time lag occurs due to the communication state of the network N, the registration apparatus 5 acquires the commodity code and the time information output from the device control terminal 7 later than usual. As a result, after the closing information of the transaction B has been input in ACT 19, the registration apparatus 5 acquires the commodity code output from the device control terminal 7 in ACT 18. Therefore, the commodity information on the commodity code is not included in the transaction information set in ACT 20. In the following description, as a result of the registration apparatus 5 acquiring the commodity code later than usual due to the communication time lag, a commodity code that should be included (but is not yet) in the transaction information is also referred to as a “delayed commodity code”.

When the registration apparatus 5 acquires the delayed commodity code and the time information corresponding to the delayed commodity code, the registration apparatus 5 compares the time indicated by the time information with the time at which the closing information of the transaction B (start information of a transaction C) was input (ACT 22). In this case, the time at which the closing information of the transaction B is input is later than the time indicated by the time information acquired by the registration apparatus 5. Accordingly, the registration apparatus 5 can recognize that a commodity related to the delayed commodity code is related to the transaction B. If the registration apparatus 5 does not acquire completion information from the payment apparatus 6 during comparison in ACT 22, the registration apparatus 5 outputs, to the payment apparatus 6, commodity information on the delayed commodity code and the transaction ID for identifying the transaction B (ACT 23).

The payment apparatus 6 incorporates the delayed commodity code into the transaction information of the transaction B and then executes a payment process on a condition that the transaction ID received from the registration apparatus 5 is the transaction ID of the transaction B received in ACT 20 (ACT 24). In other words, the payment apparatus 6 executes the payment process based on the transaction information received in ACT 21 and the commodity information related to the delayed commodity code received in ACT 23.

Accordingly, the commodity related to the delayed commodity code can be prevented from being included in the transaction C when this transaction should not include the commodity, and a payment process of the transaction C can be optimized. In addition, the commodity related to the delayed commodity code can be included in the transaction B that should have originally included the commodity, and the payment process of the transaction B can also be optimized.

If the registration apparatus 5 acquires the completion information from the payment apparatus 6 during the comparison in ACT 22, the registration apparatus 5 does not output the delayed commodity code to the payment apparatus 6 and registers the commodity. At this time, the registration apparatus 5 can prevent the commodity related to the delayed commodity code from being included in the transaction C by registering “0” in the transaction information flag of the registration information unit 5031.

In this manner, in a case where the payment process of the transaction B is completed when the registration apparatus 5 recognizes that a commodity related to the delayed commodity code should have been included in the transaction B, the commodity related to the delayed commodity code can be prevented from being included in the transaction C, and the payment process of the transaction C can be optimized. When the scanner 8 is directly connected to the network N rather than via the device control terminal 7, the process executed by the device control terminal 7 shown in FIG. 8 may be executed by the scanner 8.

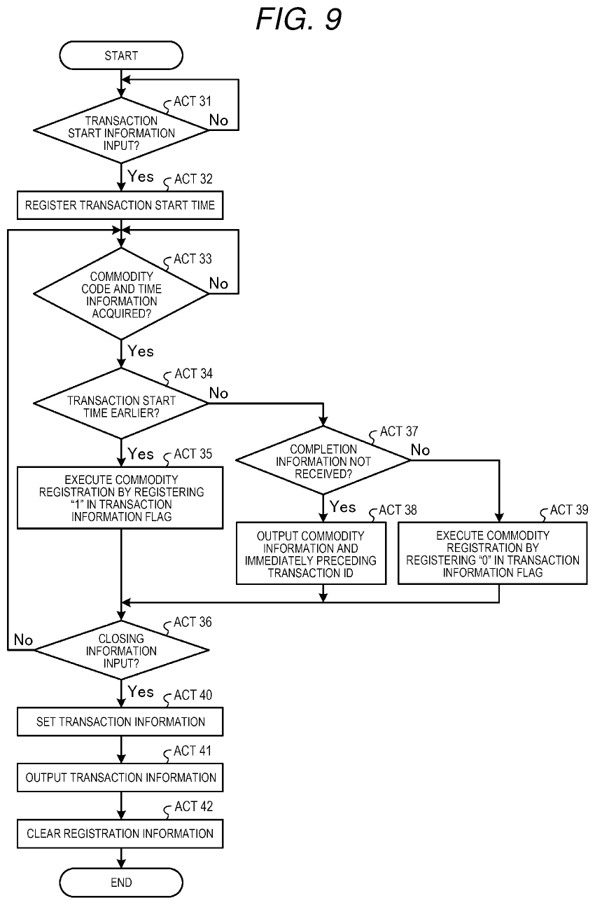

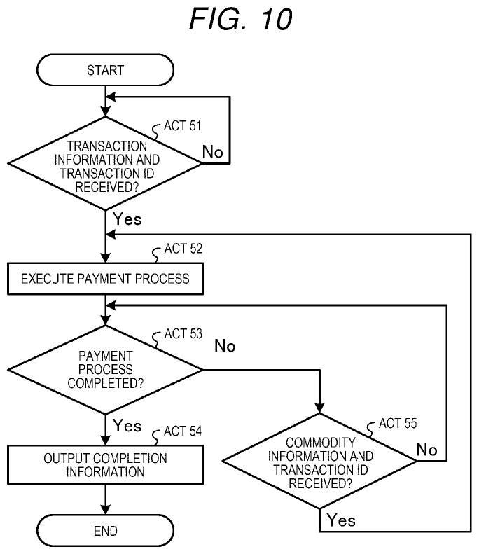

Next, a registration process executed by the registration apparatus 5 will be described. FIG. 9 is a flowchart showing a flow of the registration process executed by the control unit 50 of the registration apparatus 5.

The control unit 50 determines whether the transaction start information has been input to the input unit 5003 (ACT 31). If the transaction start information is not yet input (No in ACT 31), the process returns to ACT 31 and waits. As described above, in the present embodiment, the transaction start information is the closing information of the immediately preceding transaction. If the transaction start information has been input to the input unit 5003 (Yes in ACT 31), the registration unit 5002 registers, in the time information unit 5032, the time information indicating the time at which the transaction start information was input to the input unit 5003 (ACT 32).

Subsequently, the control unit 50 determines whether the acquisition unit 5001 acquires a commodity code and time information from the device control terminal 7 (ACT 33). If the acquisition unit 5001 does not acquire commodity code and time information (No in ACT 33), the process returns to ACT 33 and waits. If the acquisition unit 5001 acquires a commodity code and time information (Yes in ACT 33), the registration unit 5002 compares the time at which the transaction start information was input to the time indicated by the time information acquired by the acquisition unit 5001 (ACT 34).

If the time at which the transaction start information was input is earlier (Yes in ACT 34), the registration unit 5002 executes the commodity registration by registering the commodity information in each item of the registration information unit 5031 and registering “1” in the transaction information flag (ACT 35). Then, the control unit 50 determines whether the closing information is input to the input unit 5003 (ACT 36).

In the process of ACT 34, if the time at which the transaction start information was input is later (No in ACT 34), the registration unit 5002 determines whether the reception unit 5005 has not yet received the completion information indicating the completion of the payment process of the immediately preceding transaction from the payment apparatus 6 (ACT 37).

If the reception unit 5005 has not receive the completion information for the immediately preceding transaction from the payment apparatus 6 (Yes in ACT 37), the output unit 5006 outputs, to the payment apparatus 6, the commodity information that is related to the commodity code acquired by the acquisition unit 5001 from the device control terminal 7 and a transaction ID of the immediately preceding transaction (ACT 38). Then, the control unit 50 proceeds to the process of ACT 36.

If the reception unit 5005 has received the completion information of the immediately preceding transaction from the payment apparatus 6 (No in ACT 37), the registration unit 5002 executes the commodity registration by registering the commodity information in each item of the registration information unit 5031 and registering “0” in the transaction information flag (ACT 39). Then, the control unit 50 proceeds to the process of ACT 36.

In the process of ACT 36, if the closing information is not yet input to the input unit 5003 (No in ACT 36), the control unit 50 returns to the process of ACT 33. If the closing information is input to the input unit 5003 (Yes in ACT 36), the setting unit 5004 sets the transaction information (ACT 40). The setting unit 5004 refers to the registration information unit 5031 to extract the commodity information in which “1” is registered in the transaction information flag, and sets the extracted commodity information as the transaction information.

Next, the output unit 5006 outputs the set transaction information to the payment apparatus 6 (ACT 41). The registration unit 5002 clears the information registered in the registration information unit 5031. Then, the control unit 50 ends the registration process.

By the registration process, when the registration apparatus 5 acquires a delayed commodity code due to the communication time lag, the registration apparatus 5 can output appropriate information to the payment apparatus 6 as described below.

First, if the registration apparatus 5 acquires the delayed commodity code during a period between when the transaction start information of the one transaction is input to when the closing information of the transaction is input, the commodity information on the delayed commodity code is not included in the transaction information of the one transaction. Accordingly, the transaction information of the one transaction can be output to the payment apparatus 6 as the appropriate information.

Second, if the registration apparatus 5 acquires the delayed commodity code during the period between when the transaction start information of the one transaction is input to when the closing information of the one transaction is input, but the payment process related to the transaction immediately before the one transaction is not yet completed, the registration apparatus 5 outputs the delayed commodity code to the payment apparatus 6. In other words, if the payment process of the transaction that should have included the commodity indicated by the delayed commodity code is not yet completed, the delayed commodity code is output to the payment apparatus 6. Accordingly, information on the transaction (the immediately preceding transaction) that should include the commodity indicated by the delayed commodity code can also be output to the payment apparatus 6 as the appropriate information.

Next, a checkout process executed by the payment apparatus 6 will be described. FIG. 10 is a flowchart showing a flow of the checkout process by the control unit 60 of the payment apparatus 6.

The control unit 60 determines whether the receiving unit 6001 receives the transaction information and the transaction ID (ACT 51). If the receiving unit 6001 does not receive the transaction information and the transaction ID (No in ACT 51), the process returns to ACT 51 and waits. If the receiving unit 6001 receives the transaction information and the transaction ID (Yes in ACT 51), the payment processing unit 6003 executes the payment process based on the transaction information received by the receiving unit 6001 (ACT 52).

Subsequently, the control unit 60 determines whether the payment processing unit 6003 completes the payment process (ACT 53). In other words, the control unit 60 determines whether the process necessary for the customer C to pay the purchase price has been executed by the payment apparatus 6.

If the payment process by the payment processing unit 6003 is completed (Yes in ACT 53), the output unit 6004 outputs the completion information to the registration apparatus 5 (ACT 54). Then, the control unit 60 ends the checkout process.

In the process of ACT 53, if the payment process by the payment processing unit 6003 is not completed (No in ACT 53), the control unit 60 next determines whether the receiving unit 6001 receives the commodity information and the transaction ID from the registration apparatus 5 (ACT 55). If the receiving unit 6001 receives the commodity information and the transaction ID from the registration apparatus 5 (Yes in ACT 55), the control unit 60 returns to the process of ACT 52. The payment processing unit 6003 executes the payment process including the commodity information received by the receiving unit 6001. If the receiving unit 6001 does not receive the commodity information and the transaction ID from the registration apparatus 5 (No in ACT 55), the control unit 60 returns to the process of ACT 53.

By the checkout process, the payment apparatus 6 can execute the appropriate payment process based on the transaction information received from the registration apparatus 5, and the like.

As described above, a commodity data registration apparatus (e.g., a registration apparatus 5) according to an embodiment is connected, via the network N, to the input device (e.g., a device control terminal 7) to which commodity identification information (e.g., a commodity code) for identifying a commodity is input. The commodity data registration apparatus includes: an acquisition unit 5001 configured to acquire, from the input apparatus, the commodity identification information and time information indicating a time at which the commodity identification information was input; a registration unit 5002 configured to register commodity information based on the commodity identification information acquired by the acquisition unit 5001; an input unit 5003 to which transaction start information that declares the start of one transaction and closing information that declares end of the transaction are input; a setting unit 5004 configured to set, as transaction information, the commodity information registered by the registration unit 5002 during the period from when the transaction start information is input to when the closing information is input; and an output unit 5006 configured to output the transaction information as set by the setting unit 5004. When the time indicated by the time information that is associated with the commodity identification information acquired by the acquisition unit 5001 is earlier than a time at which the transaction start information is sent to the input unit 5003, the setting unit 5004 does not include the commodity information of the commodity identified by the commodity identification information in the transaction information.

Accordingly, if a delayed commodity code is acquired during the period from when the transaction start information of the one transaction is input to when the closing information of the transaction is input, the registration apparatus 5 can make the transaction information of the transaction appropriate. Therefore, the payment process executed by the payment apparatus 6 can be optimized.

The output unit 5006 of the commodity data registration apparatus according to one embodiment outputs the transaction information to the payment apparatus 6 that executes the payment process based on the transaction information.

Accordingly, the registration apparatus 5 can be applied to a POS system 4 in which the registration apparatus and the payment apparatus are operated by different operators and problems related to the appropriate payment process not being executed due to a delayed commodity code can be made obvious so such problems may be efficiently corrected or otherwise addressed.

A commodity data registration apparatus according to one embodiment further includes: the reception unit 5005 configured to receive, from the payment apparatus 6, the completion information indicating the completion of the payment process of the one transaction that is ended by the immediately preceding closing information input to the input unit 5003. The output unit 5006 outputs the commodity information that is not included in the transaction information by the setting unit 5004 to the payment apparatus 6 if the reception unit 5005 does not receive the completion information.

Accordingly, the registration apparatus 5 can output, to the payment apparatus 6, information for the transaction that should include the commodity indicated by the delayed commodity code, as appropriate information. Therefore, the payment process executed by the payment apparatus 6 can be optimized.

In addition, the closing information of one immediately preceding transaction is input to the input unit 5003 of the commodity data registration apparatus according to the present embodiment as the transaction start information.

Accordingly, the closing information of the immediately preceding transaction can be used as the transaction start information, and the operator who operates the registration apparatus 5 does not need to input transaction start information separately from the closing information. Therefore, the registration apparatus 5 can improve efficiency of the operator.

According to an embodiment, a control program executed by the registration apparatus 5 or the payment apparatus 6 may be provided by being recorded in a non-transitory computer-readable recording medium such as a CD-ROM. The control program executed by the registration apparatus 5 and/or the payment apparatus 6 may be stored in a computer connected to a network such as the Internet and provided by being downloaded via the network, or may be accessed via a network such as the Internet.

While certain embodiments have been explained above, the embodiments are presented by way of example only, and are not intended to limit the scope of the disclosure. The embodiments can be implemented in various other forms, and various omissions, substitutions, and modifications may be made without departing from the spirit of the disclosure. The embodiments and modifications thereof are included in the scope and gist of the disclosure, and are included in the invention disclosed in the scope of claims and an equivalent scope thereof.

What is claimed is:

1. A commodity data registration apparatus connectable to a commodity data input apparatus via a network, the commodity data registration apparatus comprising:
a processor configured to:
acquire, from a commodity data input apparatus, commodity identification information and associated time information indicating a time at which the commodity identification information was input to the commodity data input apparatus;
register commodity information in a transaction based on the acquired commodity identification information;
receive a transaction start to declare a start of a transaction from an operator input unit;
receive a transaction closing to declare an end of the transaction from the operator input unit;
include commodity information registered during a period between the transaction start of the transaction and the transaction closing of the transaction in transaction information; and
output the transaction information to a payment processing apparatus, wherein
when the time indicated by the time information associated with the commodity identification information is earlier than the time at which the transaction start is received, the commodity information of the commodity associated with the commodity identification information is not included in the transaction information.

2. The commodity data registration apparatus according to claim 1, wherein the transaction information is output to the payment processing apparatus via the network.

3. The commodity data registration apparatus according to claim 1, wherein the processor is further configured to:
receive, from the payment apparatus, completion information indicating a completion of the payment process of an immediately preceding transaction; and
output any commodity information associated with time information indicating the time at which the commodity information was input to the commodity data input apparatus is before the time at which the transaction start is received up until the completion information is received from the payment processing apparatus.

4. The commodity data registration apparatus according to claim 1, wherein the transaction start is a transaction closing of an immediately preceding transaction.

5. The commodity data registration apparatus according to claim 1, wherein the network is a wireless network.

6. The commodity data registration apparatus according to claim 1, wherein the commodity identification information is a commodity code.

7. The commodity data registration apparatus according to claim 1, further comprising:
the operator input unit by which an operator inputs the transaction start and the transaction closing.

8. The commodity data registration apparatus according to claim 1, wherein the processor is a central processing unit.

9. The commodity data registration apparatus according to claim 1, wherein the commodity data input apparatus is a device control unit.

10. The commodity data registration apparatus according to claim 1, wherein the commodity data input apparatus is a commodity code scanner.

11. A payment system, comprising:
a commodity data input apparatus by which commodity identification information for identifying a commodity is input;
a registration apparatus for registering commodities in transactions based on commodity identification information from the commodity data input apparatus sent via a network to the registration apparatus; and
a payment apparatus connected to the registration apparatus and configured to execute settlement processing for a transaction based on transaction information for the transaction sent by the registration apparatus, wherein
the registration apparatus comprises a processor configured to:
acquire, from the commodity data input apparatus, commodity identification information and associated time information indicating a time at which the commodity identification information was input to the commodity data input apparatus;
register commodity information in a transaction based on the acquired commodity identification information;
receive a transaction start to declare a start of a transaction from an operator input unit;
receive a transaction closing to declare an end of the transaction from the operator input unit;
include commodity information registered during a period between the transaction start of the transaction and the transaction closing of the transaction in transaction information; and
output the transaction information to the payment processing apparatus, wherein
when the time indicated by the time information associated with the commodity identification information is earlier than the time at which the transaction start is received, the commodity information of the commodity associated with the commodity identification information is not included in the transaction information.

12. The payment system according to claim 11, wherein the payment apparatus comprises:
a communication unit configured to receive the transaction information from the commodity data registration apparatus; and
a payment processing unit configured to execute a payment process based on the received transaction information.

13. The payment system according to claim 11, wherein the commodity data input apparatus is a device control unit.

14. The payment system according to claim 11, wherein the commodity data input apparatus is a commodity code scanner.

15. The payment system according to claim 11, wherein the processor of the registration apparatus is further configured to:
receive, from the payment apparatus, completion information indicating a completion of the payment process of an immediately preceding transaction; and
output any commodity information associated with time information indicating the time at which the commodity information was input to the commodity data input apparatus is before the time at which the transaction start is received up until the completion information is received from the payment processing apparatus.

16. The payment system according to claim 11, wherein the transaction start is a transaction closing of an immediately preceding transaction.

17. The payment system according to claim 11, wherein the network is a wireless network.

18. A method for a commodity data registration apparatus connected, via a network, to a commodity data input apparatus by which commodity identification information for identifying a commodity is input, the method comprising:
acquiring, from a commodity data input apparatus, commodity identification information and associated time information indicating a time at which the commodity identification information was input to the commodity data input apparatus;
registering commodity information in a transaction based on the acquired commodity identification information;
receiving a transaction start to declare a start of a transaction from an operator input unit;
receiving a transaction closing to declare an end of the transaction from the operator input unit;
including commodity information registered during a period between the transaction start of the transaction and the transaction closing of the transaction in transaction information; and
outputting the transaction information to a payment processing apparatus, wherein
when the time indicated by the time information associated with the commodity identification information is earlier than the time at which the transaction start is received, the commodity information of the commodity associated with the commodity identification information is not included in the transaction information.

19. The method according to claim 18, further comprising:
receiving, from the payment apparatus, completion information indicating a completion of the payment process of an immediately preceding transaction; and
outputting any commodity information associated with time information indicating the time at which the commodity information was input to the commodity data input apparatus is before the time at which the transaction start is received up until the completion information is received from the payment processing apparatus.

20. The method according to claim 18, wherein the transaction start is a transaction closing of an immediately preceding transaction.
